(19) United States
(12) Patent Application Publication
(10) Pub. No.: US 2017/0057014 A1
(43) Pub. Date: Mar. 2, 2017

(54) ADDITIVE MANUFACTURING

(71) Applicant: MATERIALS SOLUTIONS LIMITED, WORCESTER (GB)

(72) Inventors: TREVOR ILLSTON, WORCESTER (GB); PRATIK YATIN VORA, WORCESTERSHIRE (GB)

(21) Appl. No.: 15/242,770

(22) Filed: Aug. 22, 2016

(30) Foreign Application Priority Data
Aug. 28, 2015 (GB) 151386.9

(51) Int. Cl. B23K 26/342; B26F 3/06; B33Y 40/00; B33Y 10/00

(52) U.S. Cl. CPC B23K 26/342; B33Y 10/00; B26F 3/06; B33Y 40/00

(57) ABSTRACT

A method is for removing a support structure from an additive manufactured metallic component. The method includes exposing the component and support structure to at least one thermal pulse so as to weaken, or break, the interface(s) between the support structure and component prior to removal of the support.

### BACKGROUND

The present invention relates to additive manufactured metallic components and in particular to methods for the removal of support structures from such components.

Additive Manufacturing is a group of processes characterised by manufacturing three-dimensional components by building up substantially two-dimensional layers (or slices) on a layer by layer basis. Each layer is generally very thin (for example between 20 to 100 microns) and many layers are formed in a sequence with the two dimensional shape varying on each layer to provide the desired final three-dimensional profile. In contrast to traditional “subtractive” manufacturing processes where material is removed to form a desired component profile, additive manufacturing processes progressively add material to form a net shape or near net shape final component.

The earliest Additive Manufacturing processes, such as Stereolithography, were based upon the curing of photo-polymers using UV light and several techniques exist for forming plastic parts (including so called “3D printing” which is typically used to refer to Additive Manufacturing of plastics based upon modified inkjet type printing methods).

The Additive Manufacturing of metals presents significantly different issues to that of plastics and may be considered a distinct field by those skilled in the art. Metal powder bed Additive Manufacturing techniques are all based upon the basic principle of building a “slice” based upon a 3D CAD file by directing a point source of energy across the surface of a layer of metal powder. The energy spot is of sufficient intensity to locally melt (or sinter) the powder layer where it strikes it and creates a liquid melt pool (typically of a depth of that layer and at least half of the underlying layer of powder or, if there is a solid layer underneath, some of that underlayer). As the energy spot moves on (directed by the optics of the Additive layer manufacturing machine) the melt pool cools and the metal re-solidifies creating a contiguous whole of that layer and the underlayers. Upon completion of a layer, a new layer of powder is provided to allow the next slice to be formed.

Alternative metal Additive Manufacturing techniques may use powder (or wire) melted and applied as a liquid by mechanically scanning across a workpiece. The point source of energy may for example be a laser or electron beam and several commercially available powder bed metallic additive manufacturing systems are known. For example including methods known and/or trade marked as ‘selective laser sintering’, selective laser melting, Laser Cusing™ and DMLS™. Examples of commercially available additive manufacturing machines for producing metallic components include, for example, selective laser machines include the EOS M2XX or M4XX series (produced by EOS GmbH) and electron beam machines such as those produced by Acram AB of Sweden.

Additive manufacturing is capable of producing extremely complex parts at close to “net shape” but it will be appreciated by those in the art that support structures are generally required during manufacture. The support structures are integrally formed along with the component during additive manufacture on a layer-by-layer basis. For example, support structures may be required to sustain overhanging parts/surfaces. Support structures are particularly important in metallic components (especially high strength metals) since the heating and cooling necessary in the additive process creates residual stresses within the part which have the potential to causes geometric distortion and/or cracking of the part.

Support structures must be carefully designed and optimised during the pre-manufacturing process so as to be attached to the component with sufficient mechanical strength to function as intended, but also be relatively easy to remove after manufacture. Typically, the support structures may include a distinct interface region where they meet the component which has a lattice or toothed profile to provide a clearly defined separation line to the component. However, particularly for high performance metals (such as superalloys), the interface must be very strong and as a result the supports structure is difficult to remove. Sharp cutting tools are used with considerable force and there is a danger that the surface of component may be damaged during this removal process.

### SUMMARY

Thus, there is a need for improved methods for the removal of support structures from metallic components produced by additive manufacturing.

According to a first aspect of the invention there is provided a method of removing a support structure from an additive manufactured metallic component, the method comprising exposing the component and support structure to at least one thermal pulse so as to weaken or break the interface(s) between the support structure and component prior to removal of the remaining support.

In the event that the thermal pulse is only used to weaken the interface(s) the removal may be by mechanical removal (for example cutting). If thermal pulse(s) are used to break the interface(s) entirely it may be possible to simply remove the support, for example under gravity.

In accordance with a second aspect of the invention, there is provided a method of additive manufacturing metallic components, the method comprising the steps of:

forming a component in a layer-by-layer process, the component being formed integrally formed with at least one support structure to be separated from the component after the layer-by-layer process; and wherein after completion of the layer-by-layer process, the method comprises: exposing the component and support structure to at least one thermal pulse so as to weaken or break the interface(s) between the support structure and component; and removing the remaining support from the component.

It will be appreciated that the support structure will have been integrally formed with the component during the layer-by-layer process. The mechanical removal of the support from the component may be by conventional means (for example cutting or machining and may include advanced cutting/machining methods such as electrical discharge machining).

The support may comprises a bulk support and the interface comprises a plurality of interface support members connecting between the bulk support and the component. During the process of the invention the interface support members are weakened (or broken) by the thermal pulse prior to the mechanical removal of the support. (for example by cutting)

The applicants have found that subjecting the component and support structure to a thermal pulse removes a surface layer and thereby reduces the strength of the interface (or may break at least some of the interface) between the support structure and component without having any notable adverse effect on the material properties of the component. In fact the thermal pulse may improve the fatigue properties of the part.

The thermal pulse is at a temperature exceeding the melting point of the metallic material. The thermal pulse may provide a peak temperature increase of at least 2000° C., for example an increase of between approximately 2500 to 3500° C.

The thermal pulse may be of insufficient duration to bulk heat the component. The thermal pulse may for example be of less than 100 milliseconds in duration, for example less than 20 milliseconds in duration.

As the thermal pulse is of a relatively short duration the thermal conductivity into the bulk of the component is low. For example, due to the very short duration, the bulk component temperature may increase by only less than 200° C., for example by between approximately 50-150° C.

In contrast as the interface is formed of fine features they are subjected to a greater heat transfer. Without being bound by any particular theory it is, therefore, believed that the thermal pulse causes a localised (or selective) vaporisation, oxidation or melting of the interface features. Thus, the interface is weakened and in some parts may be broken and the support can be more easily removed.

The step of exposing the component and support structure to a thermal pulse comprises placing the component and support structure in a chamber, filling the chamber with a combustible gas mixture, allowing the gas mixture to surround the component and support structure and igniting the gas mixture. By allowing the gas mixture to fully mix with the structure and support prior to ignition the gas mixture may permeate any open spaces or voids within the component and support structure before combustion. In particular the gas mixture is able to permeate into the spaces or voids surrounding the interface. The gas mixture may be a mixture of a hydrocarbon (for example methane) and oxygen (which may for example be provided as air). The chamber may be at an increased atmospheric pressure (for example 400 bar and peak pressure during combustion may for example reach 2000 bar or more).

The combustion of the gas mixture may be such that the thermal pulse is an explosive or pseudo-explosive ignition.

The metallic component and support structure may be formed on a baseplate. As will be appreciated by those skilled in the art the component and support structure may essentially be welded to the baseplate during the additive manufacture process (as the first layer is formed on the baseplate).

Prior to the removal of the support structure from the additive manufactured metallic component the embodiments may further comprises the step of heat treating the metallic component and the support structure to remove or reduce residual stresses induced the layer-by-layer process. In order to avoid distortion due to residual stress such heat treatment may be carried out prior to the removal of the component from the baseplate. The support structure and metallic component may be removed from the baseplate together and as such the heat treatment may take place prior to the removal of the support structure in accordance with embodiments of the invention.

It will be appreciated that a plurality of components and associated support structures may be formed on a single baseplate prior during a single additive process (and this would not impact the applicability of the present invention).

The skilled person will appreciate that the step of heat treating the additive manufactured component (typically whilst still attached to the base plate) is a known process for the removal/reduction of residual stress and is distinct from the thermal pulse of embodiments of the invention. For example, such heat treatment is typically carried out in under inert or vacuum atmospheric conditions (i.e. a non-oxidising environment). Further the heat treatment must be at a temperature below the melting point of the metallic material. During such heat treatment processes bulk heating (but not melting) of the component is intended to occur.

After mechanical removal of the support structure from the metallic component, at least one further thermal pulse may be applied to the separated metallic component. In some embodiments a plurality of thermal pulses may be applied post separation.

The applicants have, surprisingly, found that the application of a further thermal pulse after removal of the support structure is provides an improved surface finish by reducing surface roughness. For example, this may reduce surface roughness resulting from remnants of the support structure interface or surface roughness of downward facing surfaces (which those in the art will appreciate may typically exhibit a degree of inherent roughness as a result of unintended powder melting below the layer desired).

The additional thermal pulse treatment of the separated component may be followed by the surface of the metallic component being abrasively cleaned. For example, the surface may be subject to abrasive blasting.

The abrasive cleaning removes the oxide produced by the thermal pulse treatment. Whilst not being bound by any particular theory, it is believed that the combination of the thermal pulse and subsequent abrasive treatment is particularly advantageous by at least partially oxidising, vaporising or melting the local fine peaks in the surface to enable or encourage their selective removal during the subsequent abrasive treatment.

The additive manufacturing process in accordance with embodiments of the invention may comprise powder bed selective laser manufacturing.

Whilst the invention has been described above, it extends to any inventive combination of features set out above or in the following description or drawings. Further, any optional features described above with respect to embodiments of the first aspect of the invention are expressly considered to be equally applicable to the second aspect of the invention and visa versa.

### BRIEF DESCRIPTION OF THE DRAWINGS

Specific embodiments of the invention will now be described in detail, by way of example only, and with reference to the accompanying drawings in which:

FIG. 1 is a schematic representation of a part manufactured by a conventional additive manufacturing method;

FIG. 2 shows examples metal parts formed by additive manufacturing with support structures both present and removed; and

FIG. 3 shows a flow chart for the forming an additive manufactured component in accordance with embodiments of the invention.

### DETAILED DESCRIPTION OF EMBODIMENTS

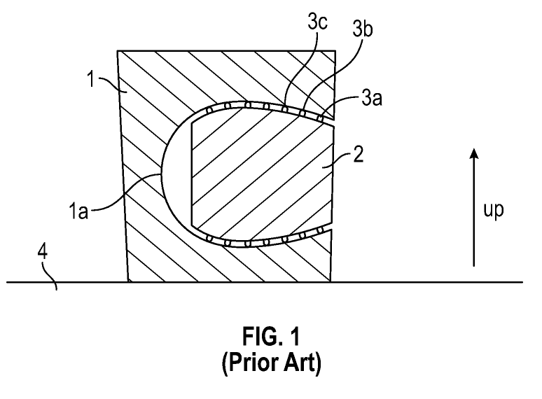

A schematic representation of a metal part 1 manufactured in an additive manufacturing method is shown in FIG. 1. The metal part is for example a casing and includes a cavity la within its body. The part 1 is formed by being built up on a layer-by-layer manner on a baseplate 4 in a manner which will be well known to those skilled in the art.

A bulk support structure 2 is provided within the cavity la of the part 1. The bulk support is arranged to be built relatively quickly during the additive layer manufacture but to have sufficient strength to resist the loads from the part 1 and, for example to resists geometric distortion of the part 1. The skilled person will appreciate that the support 2 may have any convenient (optimised) form and could be a solid or for example a lattice or honeycomb structure.

To ensure that the support 2 can be removed from the component 1 after manufacture it is provided with an interface 3 which forms a distinct “break line” between the support 2 and component 1. The interface may comprise a number of distinct, tooth like, interface members 3a, 3b, 3c which join the component 1 and support 2. It will be appreciated that the component 1, support 2 and interface 3 are all integrally formed on a layer-by-layer basis during the additive manufacturing process.

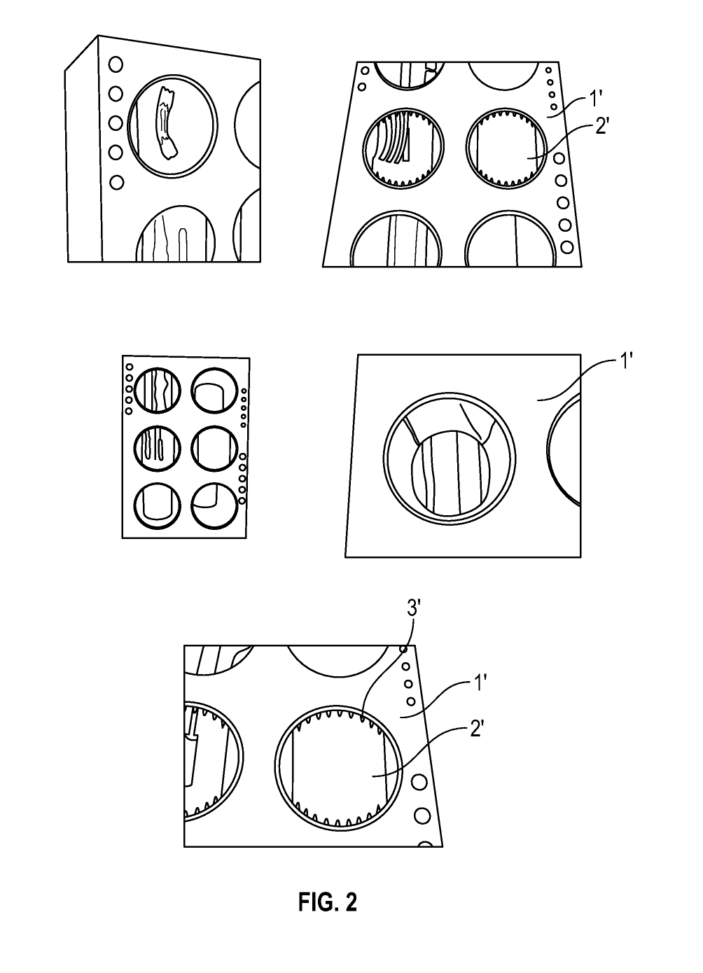

Some example photographs are shown in FIG. 2 to illustrate the removal of a support structure 2′ from a component 1′ using the method in accordance with embodiments of the invention. It may be noted that the photographs show the support 2′ both in situ, partially removed and after removal (with remnants of the interface showing).

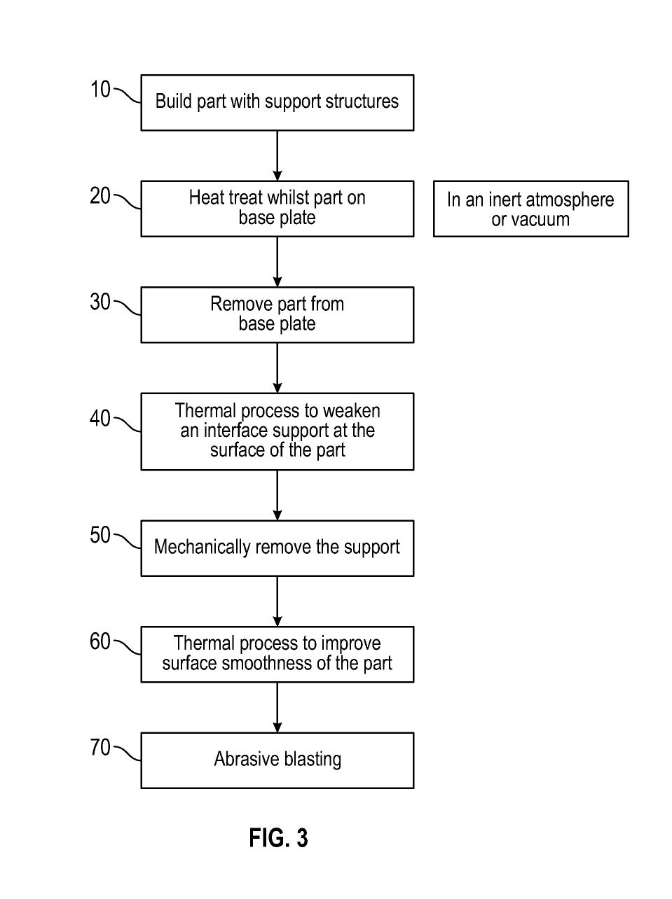

The method in accordance with an embodiment of the invention is shown by the flow chart of FIG. 3. In the initial step 10 a component is built along with support structures by a known metallic additive manufacture process. A subsequent heat treatment 20 is applied to the part after removal from the additive layer manufacturing machine (but with the part remaining attached to the baseplate to resist deformation. This heat treatment is in a non-oxidising atmosphere (inert or vacuum) and is intended to reduce or minimise residual stresses.

With the residual stresses reduced by the heat treatment process 20, the component may processed 30 to remove it from the baseplate (but will still have associated support structure attached or embedded within it).

After this removal the part and support structure are subjected to a thermal pulse process 40 to weaken the interfaces between the support and component. This thermal pulse is carried out in a sealed chamber at increased pressure. The chamber is filled with methane and air which is allowed to fully surround the component prior to ignition to provide extremely rapid and high temperature combustion (an explosive or pseudo explosive process). The thermal pulse may for example last approximately 20 milliseconds and result in an increase in temperature within the chamber of between 2500° C. and 3500° C. and a pressure spike of up to 2000 bar. The heat will strike the surfaces of the component and support structure but is of insufficient duration to cause bulk heating thereof. The thermal pulse step may for example be carried out using a conventional thermal deburring apparatus.

The thermal pulse step 40 has been found to weaken the interface parts 3 of the support 2 but since it does not cause any bulk heating of the component 1 it does not cause any change in its material properties. In contrast the interface parts are assumed to have a greater thermal conductivity so experience more significant surface oxidation and/or vaporisation and/or melting during the thermal pulse. This has been found to have provide a significant weakening of the interface and aid removal of the support (in step 50 below)

After the thermal pulse step 40, the support 50 using any convenient mechanical processing step 50 (and the skilled person will appreciate that the particular mechanical process selected may depend upon several factors such as the material and geometry of the component and support).

Once the support has been fully removed it is normal to apply a final abrasive cleaning step 70 such as abrasive blasting to remove any remaining remnants of the interface members 3 from the separated component 1. In accordance with an embodiment prior to such abrasive blasting the component may optionally be subjected to a further thermal pulse step 60. The thermal pulse step 60 may include the application of a plurality of thermal pulses.

It has surprisingly been found that the application of this additional step 70 produces a greater reduction in final surface reduction. This appears to go directly against the teaching in the art since an advantage of utilising thermal pulses in known processes such as thermal deburring is that component surfaces should not be affected. When the method of an embodiment was applied to test pieces by the applicant it was found to demonstrate a reduce surface roughness (Ra measurement), measured using a surface profilometer following the subsequent abrasive blasting process 70, of at least 30% and typically 50% to 60%.

Without being bound to any particular theory, the applicants believe that the reduction in surface roughness is a result of the residual high points of the interface (and for example high points of roughness on downward faces) being vaporised, oxidised or melted by the thermal pulse creating a selectivity to the process and thereby enabling a smoothing to take place. The surface oxide than results from the thermal process is then removed by abrasive blasting.

Although the invention has been described above with reference to a preferred embodiment, it will be appreciated that various changes or modifications may be made without departing from the scope of the invention as defined in the appended claims. For example, there may be more than one thermal pulse to process step 40 and some (or all) interface members 3a, 3b, 3c may be completely broken by the thermal pulse process step 40. Indeed the complete breaking of all interface members would be ideal—thereby allowing the simplest possible removal of the support (including by gravity). A limiting factor to interface breaking by additional thermal pulses may be an undesirable bulk heating of the part or simply cost and time—at some point it may be more desirable to mechanically cut the support away (including by unconventional methods such as electro discharge machining). In all regards though the support is mechanically removed; a thermal pulse does not of itself remove the support.

What is claimed is:

1. A method of removing a support structure from an additive manufactured metallic component, the method comprising exposing the component and support structure to at least one thermal pulse so as to weaken, or break, the interface(s) between the support structure and component prior to removal of the support.

2. The method of claim 1, wherein the support comprises a bulk support and the interface comprises a plurality of interface support members connecting between the bulk support and the component and wherein the interface support members are weakened by the thermal pulse prior to the removal of the bulk support by any other method.

3. The method of claim 1, wherein the thermal pulse is at a temperature exceeding the melting point of the metallic material.

4. The method of claim 1, wherein the step of exposing the component and support structure to a thermal pulse comprises placing the component and support structure in a chamber, filling the chamber with a combustible gas mixture, allowing the gas mixture to surround the component and support structure and igniting the gas mixture.

5. The method of claim 4, wherein the thermal pulse is an explosive or pseudo-explosive combustion.

6. A method of additive manufacturing metallic components, the method comprising the steps of:
forming a component in a layer-by-layer process, the component being formed integrally with at least one support structure to be separated from the component after the layer-by-layer process; and wherein after completion of the layer-by-layer process, the method comprises removal of the support structure from the additive manufactured metal component in accordance with claim 1.

7. The method of claim 6, wherein the metallic component and support structure is formed on a baseplate and prior to the removal of the support structure from the additive manufactured metallic component the method further comprises the steps of:
heat treating the metallic component and the support structure to remove or reduce residual stresses induced the layer-by-layer process;
and subsequently removing the component and support structure from the base plate.

8. The method of claim 1, wherein after mechanical removal of the support structure from the metallic component, at least one further thermal pulse is applied to the separated metallic component.

9. The method of claim 8, wherein a plurality of thermal pulses are applied to the separated metallic component.

10. The method of claim 8, wherein the surface of the metallic component is abrasively cleaned after the application of at least one thermal pulse to the separated metallic component.

11. The method of claim 1, wherein the additive manufacturing process comprises powder bed selective laser manufacturing.

12. The method of claim 6, wherein after mechanical removal of the support structure from the metallic component, at least one further thermal pulse is applied to the separated metallic component.

13. The method of claim 12, wherein a plurality of thermal pulses are applied to the separated metallic component.

14. The method of claim 13, wherein the surface of the metallic component is abrasively cleaned after the application of at least one thermal pulse to the separated metallic component.
